(19) United States
(12) Patent Application Publication
(10) Pub. No.: US 2010/0083629 A1
(43) Pub. Date: Apr. 8, 2010

(54) FLEXIBLE CUTTERBAR SUPPORT APPARATUS WITH INTEGRAL ADJUSTABLE TORSIONAL PRELOAD MECHANISM AND VIBRATION DAMPER

(76) Inventors: Karl W. Klotzbach, Ephrata, PA (US); James F. Rayfield, New Holland, PA (US); Jeremy Becker, Scottsbluff, NE (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/246,923

(22) Filed: Oct. 7, 2008

(51) Int. Cl. A01D 67/00; A01D 34/01

(52) U.S. Cl. 56/320.1

(57) ABSTRACT

A flexible cutterbar support apparatus with integral adjustable torsional preload mechanism for connecting a cutterbar support arm to a header frame for upward and downward movement. The mechanism includes a first element connected to the support arm and extending about a second element configured for connection to the frame, and at least one resilient biasing element disposed between the first element and the second element and biasable by generation of a torsional loading condition between the first and second elements for applying a preload force therebetween. A preload adjusting mechanism in connection with at least one of the first element and the second element is operable for selectably adjusting the biasing of the at least one resilient biasing element in a manner for adjusting the preload force. The preload mechanism is also operable for damping vibrations emanating from the cutterbar, and can be used in cooperation with apparatus for damping the up and down movements thereof.

### TECHNICAL FIELD

This invention relates generally to apparatus for supporting a flexible cutterbar on a header of an agricultural plant cutting machine, such as, but not limited to, a combine, windrower or the like, and more particularly, to support apparatus including an integral adjustable torsional preload mechanism and vibration damper which enables setting a torsionally generated preload force level for achieving desired cutterbar position and flex characteristics, and additionally which is configured for damping vibrations including those emanating from reciprocating operation of the cutterbar.

### BACKGROUND ART

An agricultural plant cutting machine, such as, but not limited to, a combine or a windrower, generally includes a header operable for severing and collecting or gathering plant or crop material as the machine is driven over a field. The header will have a plant cutting mechanism for severing the plants or crops, which can comprise an elongate sickle mechanism sidewardly reciprocatingly movable relative to a non-reciprocating guard structure. On some headers, the cutterbar and guard structure are flexible, that is, capable of flexing upwardly and downwardly at locations along the width of the header, to facilitate operation while in contact with the ground along the width of the header, and while enabling conforming to and accommodating irregularities and unevenness in the ground surface.

Typically, a flexible cutterbar is supported at spaced locations along its length on forward ends of pivoting support arms having rear ends which pivotally connect to the header. The individual pivotability of the support arms enables the respective locations of the cutterbar to flex individually, downwardly and upwardly for conforming to or accommodating ground surface irregularities, and, if the header is equipped with an automatic height control system, for triggering operation of that system.

A ground contour following capability of a flexible cutterbar can be enhanced by exerting a force against it to reduce the amount of applied external force required to move the support arm and supported portion of the cutterbar upwardly. This is desirable and advantageous, as it can improve the cutterbar flex reaction to upwardly extending ground irregularities and increased firmness and hardness, resulting in smoother operation with less jarring. It can also act to limit the downward flexure of the cutterbar into ground depressions and the like.

It would also be advantageous to provide a capability for damping intermittent shock forces generated from contact with hard objects such as rocks, and regular side to side vibrations and forces generated by the reciprocating action of the sickle, and to limit the transmission of those vibrations and forces beyond the cutterbar support assembly, particularly, to the human operator platform or cab of the associated vehicle, such as a combine or tractor.

What is sought therefore, is support apparatus for a flexible cutterbar, that provides one or more of the advantages sought therefor, and which overcomes one or more of the disadvantages and shortcomings, set forth above.

### SUMMARY OF THE INVENTION

What is disclosed is support apparatus for a flexible cutterbar, including an adjustable torsional preload mechanism that provides one or more of the advantages sought therefor, and which overcomes one or more of the disadvantages and shortcomings, set forth above.

According to a preferred aspect of the invention, the support apparatus includes an elongate support arm having a first or forward end configured for attachment in supportive relation to the flexible cutterbar, and a second or rear end opposite the first end. The adjustable torsional preload mechanism is configured for connecting the second end of the support arm to the header frame for upward and downward pivotal movement relative to the frame about a pivotal axis, while applying an adjustable preload force biasing the support arm in a desired direction. The preload mechanism includes a first element connected to the second end of the support arm and extending about a second element connected to the frame. The mechanism includes at least one resilient biasing element disposed between the first element and the second element and biasable by exertion of a torsional or twisting loading condition between the first and second elements, for applying the preload force in the desired direction against the support arm through the first element.

The apparatus additionally includes a preload adjusting mechanism in connection with at least one of the first element and the second element and operable for increasing or decreasing the torsional loading condition, to thereby increase or decrease the biasing of the at least one resilient biasing element in a manner for adjusting the preload force, particularly for urging the first element and the support arm upwardly about the pivotal axis.

According to another preferred aspect of the invention, the second element is a shaft and the first element has an inner surface bounding an interior cavity containing the shaft, and the at least one resilient biasing element comprises at least one elastomeric element disposed in the interior cavity and which is loaded in compression against the inner surface by the torsional loading condition for generating the preload force. As a nonlimiting example, the shaft can be of solid construction, having a rectangular sectional shape, and the first element can be a tubular member having the same sectional shape or otherwise configured for receiving the shaft with sufficient space therebetween for receiving the resilient biasing element or elements and accommodating relative pivotal movement of the tubular member and the shaft about the pivotal axis for generating the preload force.

According to a preferred alternative embodiment of the invention, the second element comprises a shaft, and a single elastomeric member is used and attached, e.g., bonded, to at least one sleeve or bushing, or otherwise mounted about the shaft for rotation therewith about the pivotal axis. For instance, the sleeve can be mounted to the shaft by one or more keys, pins, splines, or other device or feature which locks them together. And the first element will cooperatively engage, e.g., have a shape conforming to an outer shape of the elastomeric element, such that relative rotation of the first and second elements about the pivotal axis will create a torsional loading condition which will elastically deform the elastomeric element, here, by essentially twisting the outer portion thereof in contact with the first element, about the inner portion thereof connected to the second member, such that the elastomeric element will store energy that will be exerted in a direction opposite the direction of the relative rotation, as the preload force.

According to another preferred embodiment of the invention, a plurality of the elastomeric elements are used, disposed at spaced locations about the shaft. The elastomeric elements in this instance can include, but are not limited to, elastomeric rods or cylinders disposed between the tubular member and the shaft, such that relative pivotal or movements of the tubular member and shaft will compress the elastomeric elements such that they will store the energy that will be exerted as the preload force.

According to another preferred aspect of the invention, the preload adjusting mechanism will include a torque arm either connected directly between the first and second elements, or between the second element and the header frame, and operable for applying a torque for selectably increasing or decreasing the torsional loading condition, to thus correspondingly adjust the preload force. In this latter regard, as an example, a threaded adjusting assembly can be utilized for selectively applying the adjusting torque.

In another preferred aspect of the invention, the adjusting mechanism is configured such that, with the cutterbar suitably positioned, the mechanism will hold the second element such that the support arm and the supported portion of the flexible cutterbar are desirably positioned and biased upwardly by the preload force, to provide desired operational characteristics.

As still another preferred aspect of the invention, the at least one elastomeric element is configured to have sufficient vibration damping properties for damping vibrations generated by the side-to-side reciprocating action of the cutterbar, limit transmission of the vibrations to the frame, and to at least partially absorb shock loads from sudden contacts and impacts with ground features and irregularities.

And, according to still another preferred aspect of the invention, apparatus can be provided in cooperation with the support apparatus, for damping the upward and downward movements of the cutterbar, particularly oscillations resulting from impacts and the like. As an example in this regard, a fluid, e.g., liquid or gas, operated damper can be used.

Thus, as an advantage of the invention, a flexible cutterbar can be supported by a plurality of the support apparatus, individually adjustable for setting the preload force exerted by the elastomeric element or elements at that location, and also the free state position of the cutterbar. As another advantage, in operation, as the header is moved over the ground with the cutterbar in contact with the ground surface, the cutterbar will be supported and operable, with the preload force set at a level for providing satisfactory flexure characteristics responsive to contact with surface contours and irregularities, changing ground conditions, e.g. firmness, and the like.

### BRIEF DESCRIPTION OF THE DRAWINGS

FIG. 1 is a simplified fragmentary side view of the front end of an agricultural combine, including a header having support apparatus of the invention supporting a flexible cutterbar of the header in a ground following configuration;

FIG. 2 is an enlarged fragmentary side view of the header of FIG. 1, showing the support apparatus of the invention in a raised position, and in dotted lines in a lowered ground following position resting on a ground surface shown in phantom;

FIG. 3 is an enlarged perspective view of a representative support apparatus of the invention, including one embodiment of an integral adjustable torsional preload mechanism according to the invention;

FIG. 4 is an enlarged fragmentary perspective view of the support apparatus of FIG. 3, showing aspects of the torsional preload mechanism;

FIG. 5 is an exploded fragmentary perspective view of the support apparatus and mechanism of FIGS. 3 and 4;

FIG. 6 is an enlarged fragmentary side view of the support apparatus and mechanism;

FIG. 7 is an enlarged fragmentary schematic side view of the support apparatus and mechanism;

FIG. 8 is a simplified schematic side view of the support apparatus and mechanism, illustrated in a ground following mode;

FIG. 9 is another simplified schematic side view of the support apparatus and mechanism, illustrated in a raised mode;

FIG. 10 is a simplified schematic top view of the support apparatus and mechanism;

FIG. 11 is a fragmentary perspective view of the support apparatus, including another embodiment of an integral adjustable torsional preload mechanism of the invention;

FIG. 12 is a fragmentary side view of the support apparatus and mechanism of FIG. 11; and

FIG. 13 is a fragmentary top view of the support apparatus and mechanism of FIG. 11.

### DETAILED DESCRIPTION OF THE INVENTION

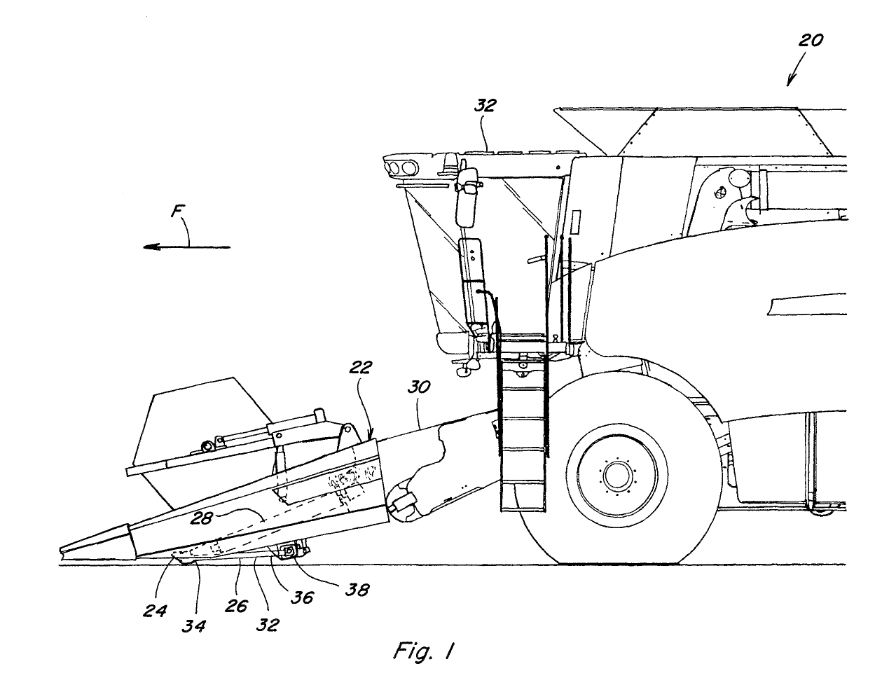

Referring to FIG. 1, a self-propelled combine 20 is shown, including a header 22 with a flexible cutterbar 24 supported by a plurality of support apparatus constructed and operable according to the teachings of the present invention, at spaced locations across the width of header 22, as represented by support apparatus 26 shown. Cutterbar 24 is a conventionally constructed and operable sickle type cutter including an elongate end-to-end array of knife sections reciprocatingly movable in a side-to-side direction relative to fixed cutter guards, for severing crops from a field as combine 20 is moved forwardly thereover, as denoted by arrow F. Header 22 additionally includes a conveyor arrangement 28 operable for gathering the cut crops, and conveying them to a center region of header 22, and into a feeder 30 of combine 20, in the well-known manner. Here, header 22 is configured as a draper type grain header, but it should be understood that it is contemplated that the apparatus of the invention has utility for use with a wide variety of headers, including also, but not limited to, those which utilize helical auger type conveyors, and those used with windrowers and other plant cutting machines. Combine 20 is also of conventional construction and operation, for separating grain from the cut crops, collecting the grain, and discharging the material other than grain. For windrower applications, combine 20 would be replaced by a tractor.

Here, it should be noted that in FIG. 1, cutterbar 24 is illustrated supported by support apparatus 26 of the invention in a float mode, such that portions of cutterbar 24 supported by the individual support apparatus 26 are in effect supported by contact with a ground surface therebeneath, and such that the cutterbar will sever the crops at or just above the ground surface. This mode is typically used for harvesting crops such as soybeans and other legumes. In this mode, the support apparatus 26 at spaced locations along the width of cutterbar 24, allows a limited range of upward and downward movement of the individual regions of cutterbar 24 supported by the respective apparatus 26, also in the well-known manner. This is a desirable capability, as it allows cutterbar 26 to flex sufficiently to generally conform to contours of a typical surface which the cutterbar will contact, such that the cutting height is maintained, and impacts and jarring that can result from contact with raised surface contours and irregularities, e.g., furrow ridges, clumps, rocks, and the like, are reduced. This flex capability may be provided in association with a header height control system (not shown) automatically operable for raising header 22 responsive to a certain extent of upward movement of cutterbar 24, and lowering the header responsive to a certain extent of downward movement, also in the well-known manner.

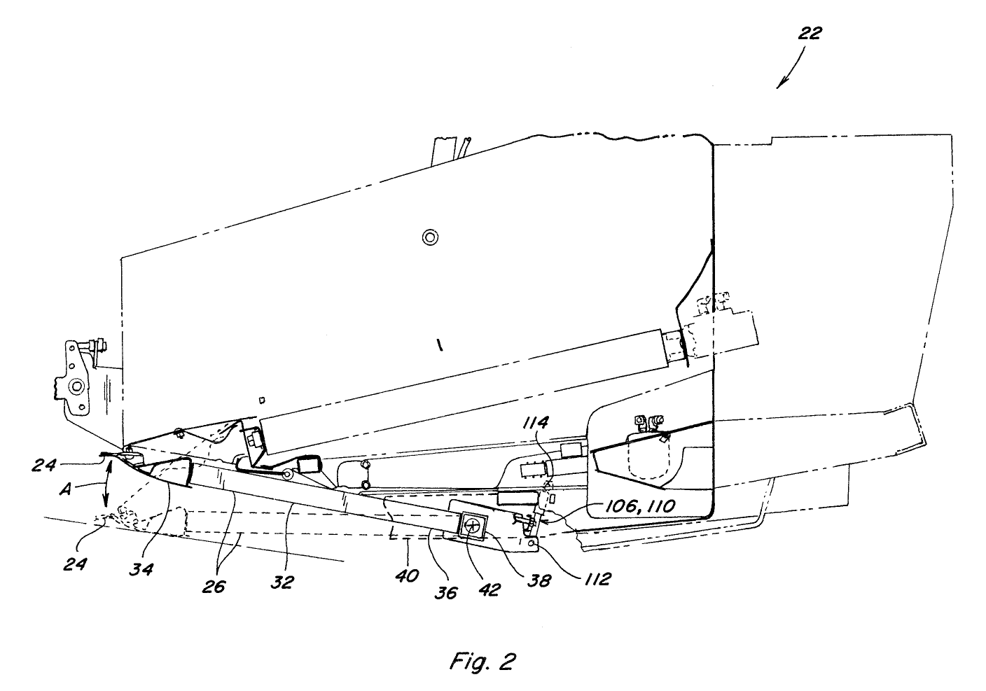

Referring also to FIG. 2, header 22 is shown illustrating cutterbar 24 supported by support apparatus 26 at about an upper extent of travel thereof, and at which height cutterbar 24 and support apparatus 26 can be fixed or locked up, as typically used for harvesting small grains such as wheat. Cutterbar 24 and support apparatus 26 are also illustrated in dotted lines at about a middle of the range of upward and downward travel. A typical cutterbar 24, which may be as much as 40 or more feet wide, will be sufficiently flexible to allow spaced apart regions of the cutterbar to be simultaneously located at different elevations, which may be required for providing some desired ground contour following capabilities. In addition to providing flexibility, cutterbar 24 and support apparatus 26 will have sufficient robustness so as to be capable of withstanding intermittent contacts and impacts with ground features, e.g., raised areas, furrow ridges, logs, rocks, etc., over the course of use. Further, to compensate at least partially for the weight of cutterbar 24 and apparatus 26; to reduce forces generated and potential damage from impacts, ground scalping, etc.; and to increase the lifting response to contact with raised ground features, obstructions, firmer ground, and the like, it is desirable to provide a preload force directed upwardly, to facilitate upward movements of the cutterbar. Still further, it is desirable to have a capability to individually adjust the level of the preload force applied at locations corresponding about to those of the individual support apparatus along the width of the cutterbar. This is advantageous for leveling or evening the height of the cutterbar when supported only by the support apparatus of the invention, if desired, and for compensating for a variety of factors such as differences between the weight of the cutterbar at different locations along the width of the header, e.g., such as at the ends where the drive mechanisms (not shown) for the sickle are located, and the like.

Furthermore, it is desirable to provide a capability for reducing the transmission of forces and vibrations generated by the reciprocating action of the cutter, and those resulting from contact with the ground, beyond the support apparatus, represented by apparatus 26, particularly to combine 20, and more particularly to operator cab 32 of the combine.

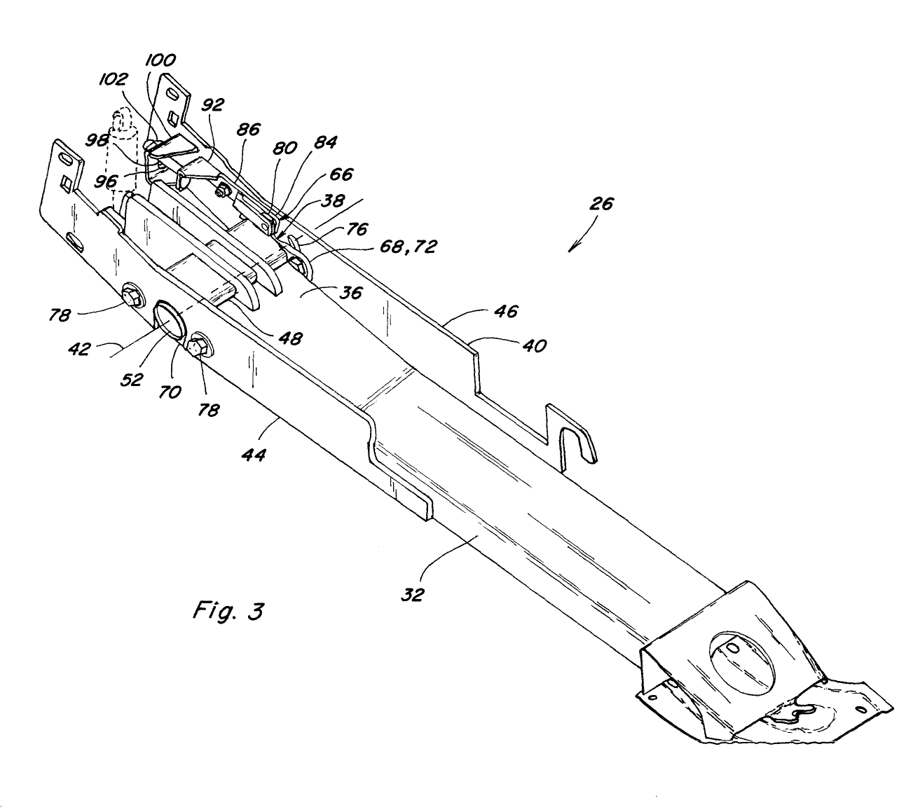

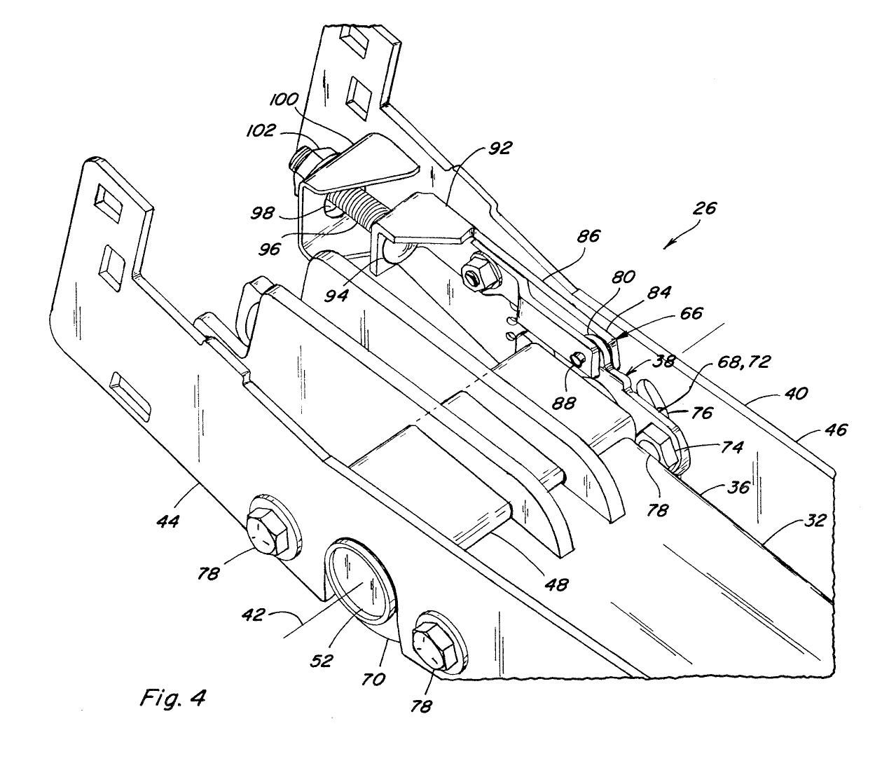

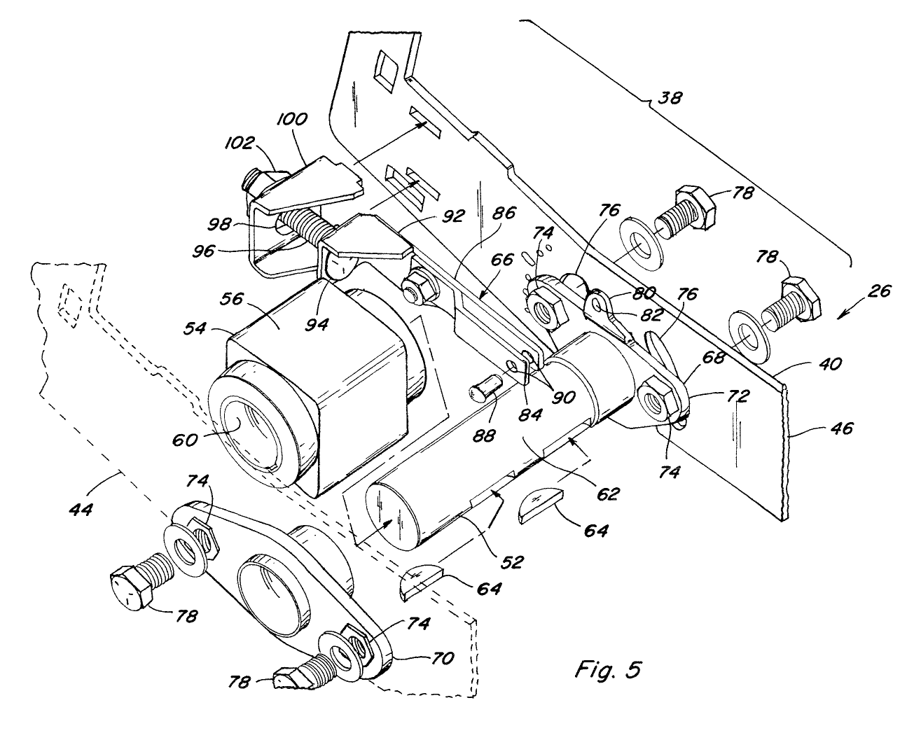

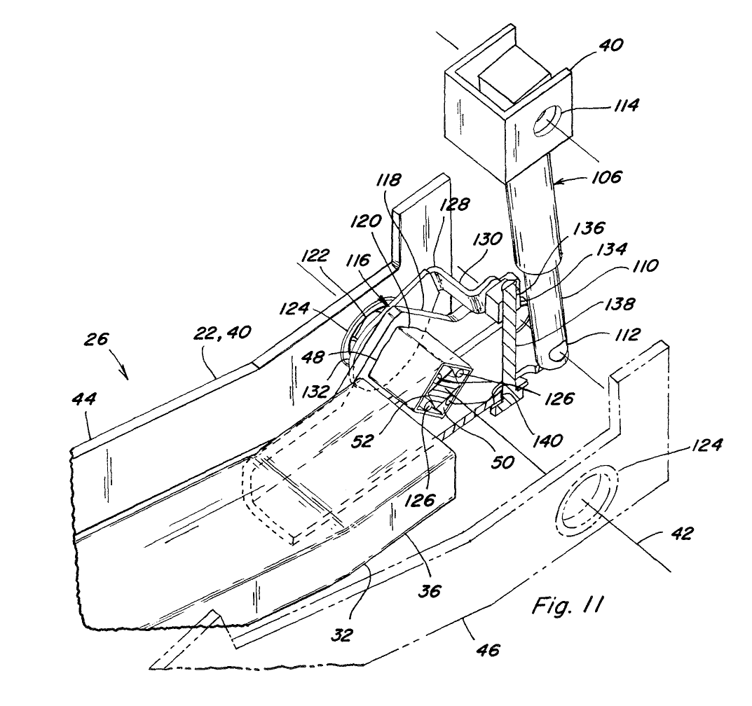

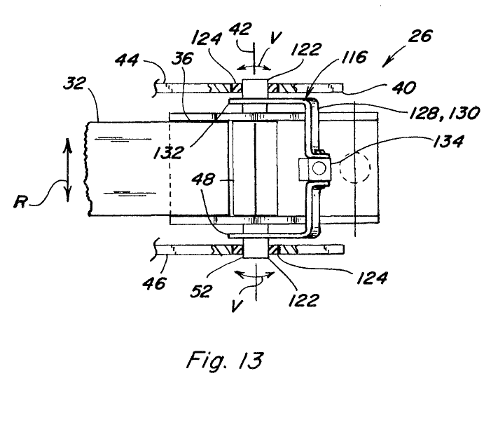

Support apparatus 26 provides one or more of the desired capabilities set forth above, by incorporating an integral adjustable torsional preload and vibration damper function, which enables setting a preload force level for achieving desired cutterbar position and flex characteristics, and additionally which is configured for damping vibrations and shocks including those emanating from side-to-side reciprocating operation of the cutterbar, and those emanating from contact or impacts with ground features and the like. Support apparatus 26 includes a basic structure which is an elongate support arm 32 having a first end 34 connected in supportive relation to cutterbar 24, such as with suitable fasteners or the like, and a second end 36 opposite first end 34. Apparatus 26 is shown in FIGS. 3 through 10 including a first embodiment 38, and in FIGS. 11 through 13, a second embodiment 116, of an adjustable torsional preload mechanism connecting second end 36 of support arm 32 to a frame 40 of header 22 for upward and downward pivotal movement relative to the frame about a pivotal axis 42, as denoted by arrow A in FIG. 2, while applying a selected level of preload force, in a desired direction, which here, is upwardly. Generally, the preload force is the product of a torsional loading condition exerted between elements of the respective mechanisms 38 and 116 by a torque applied thereto by the weight of support arm 32 and the portion of cutterbar 24 supported thereby. The torsional loading condition is created by relative pivotal or twisting movement of a first element connected to the cutterbar, and a second element connected to the frame of the header, which elastically deforms one of more elastomeric biasing elements disposed between the elements, such that the biasing element or elements store energy which is exerted as the preload force. The stored energy and resultant preload force can be adjusted and set, so as to be less than the total amount of force required for pivoting the support arm and supported portion of the cutterbar upwardly, and so as to be released with externally caused upward movements, such as when the support arm is lifted by contact with raised ground contours, firmer soil, and the like, so as to reduce the amount of externally applied force required for the upward movements.

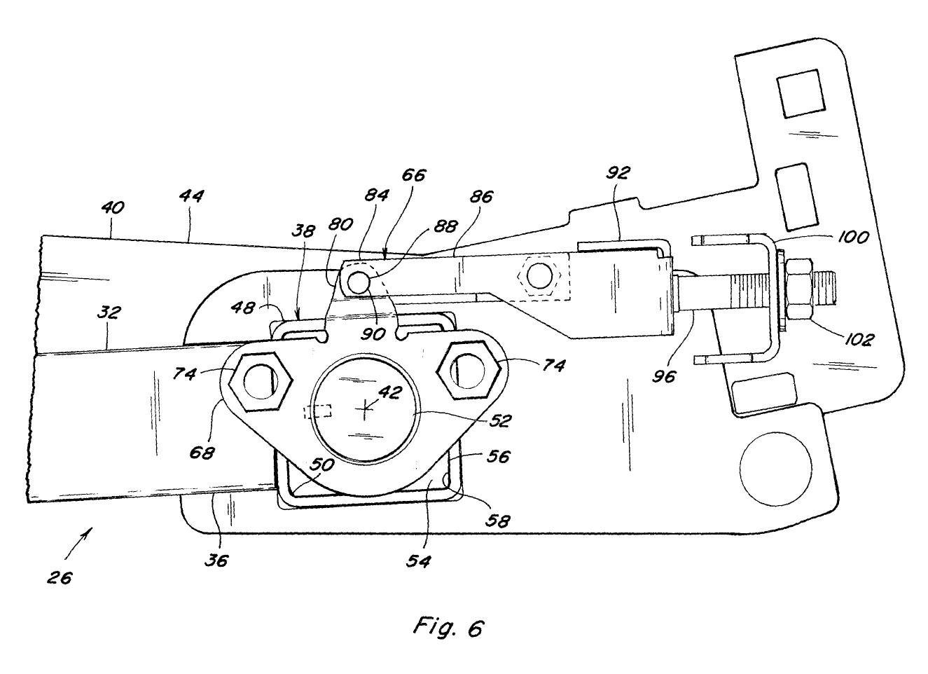

Referring also to FIGS. 3, 4, 5 and 6, adjustable torsional preload mechanism 38 of apparatus 26 is preferably mounted or connected to a suitable portion of frame 40, which can be, but is not limited to, a pair of structural ribs 44 and 46 of frame 40. Here, mechanism 38 includes a first element 48 which is a rectangular tubular member of a suitable material, such as a metal, extending transverse to support arm 32 and fixedly connected to second end 36 thereof, in a suitable manner, such as by welding. First element 48 defines and encloses a cavity 50 (FIG. 6) containing pivotal axis 42. A second element 52 which preferably comprises a shaft, and also constructed of a suitable metal material, extends through cavity 50 centered about pivotal axis 42, such that first element 48 extends about and contains second element 52.

Mechanism 38 additionally includes a resilient biasing element 54 of a suitable material, such as, but not limited to, a resiliently elastic elastomeric material, such as a natural and/or synthetic rubber, disposed in cavity 50 between first element 48 and second element 52, and which is biasable for storing energy sufficient for generating a desired preload force level. To provide this capability in this embodiment, biasing element 54 is configured to have an outer surface 56 shaped to matingly engage an inner surface 58 of first element 48, and an inner surface 60 shaped to matingly engage an outer surface 62 of second element 52. To provide robustness, second element 52 includes a cylindrical bushing of a suitable material, such as a metal, which is suitably connected to the resilient elastomeric material of element 52, such as by bonding, and which includes inner surface 60. In turn, inner surface 60 is fixedly connected to outer surface 62 of second element 52 in a suitable manner, such as with one or more keys 64 received in keyways in surfaces 60 and 62, for joint rotation or pivoting of elements 52 and 54 about axis 42.

Second element 52, and thus biasing element 54, first element 48 and support arm 32, are supported between ribs 44 and 46 of frame 40 by a preload adjusting mechanism 66 of mechanism 38, so as to be pivotable about pivotal axis 42, relative to ribs 44 and 46. Adjusting mechanism 66 includes an adjusting flange bushing 68 fixedly mounted to one end of second element 52, for pivotal movement therewith about pivotal axis 42. A fixed flange bushing 70 preferably supports the opposite end of second element 52 for free pivotal movement about axis 42. Adjusting flange bushing 68 includes a flange 72 extending radially outwardly relative to axis 42, including a pair of threaded fasteners 74. Fasteners 74 are aligned with a pair of arcuate slots 76 extending through rib 46 of frame 40, which receive a pair of bolts 78 threadedly engageable with fasteners 74, respectively. This allows a limited range of pivotal movement of bushing 68 about axis 42. Fixed flange bushing 70 is fixedly mounted to rib 44 by additional fasteners 74 and bolts 78, such that second element 52 is supported for pivotal movement about axis 42 relative to that rib. Flange 72 of bushing 68 additionally includes a radially outwardly extending torque arm 80 including a hole 82 therethrough. A bifurcated end 84 of an adjusting link 86 is pivotally connected to torque arm 80 by a pin or fastener 88 which passes through hole 82 and mating holes 90 through end 84. An opposite end 92 of adjusting link 86 has a hole 94 therethrough which receives one end of an adjusting bolt 96. This assembly allows pivotal movement of torque arm 80, with longitudinal movement of adjusting link 86 and bolt 96. Adjusting bolt 96, which can be, e.g., a carriage bolt or the like, is non-rotatable in hole 94, which can be suitably configured, e.g., rectangular, for this purpose. Bolt 96 passes through a second hole 98 through a bracket 100 fixedly mounted on rib 46, and threadedly engages a threaded fastener 102. Fastener 102 is tightenable about bolt 96 for drawing it, link 86 and the free end of torque arm 80, toward bracket 100, and is loosenable for allowing them to move away from the bracket.

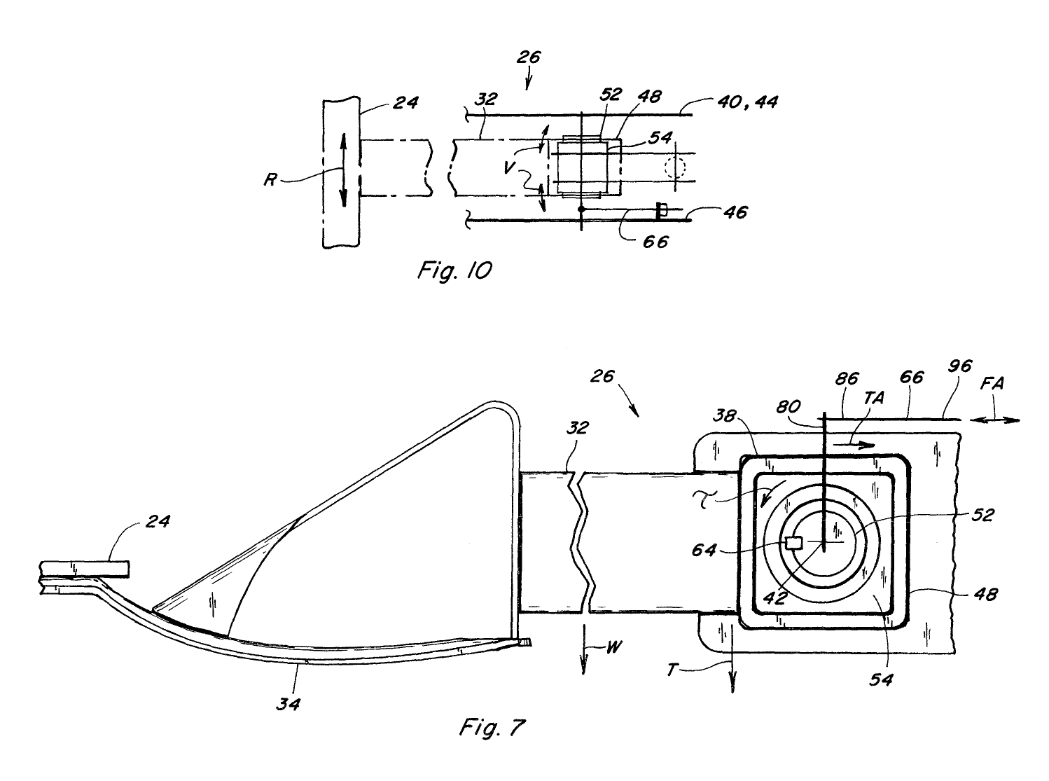

Referring also to FIGS. 7, 8 and 9, support arm 32, and the components of mechanisms 38 and 66 of support apparatus 26, are illustrated in simplified schematic form to facilitate explanation of the forces and adjustable preload generating capability of the invention. Generally, when second element 52 is held by torque arm 80 so as to be non-pivotable about axis 42, the weight of support arm 32 and that portion of the cutterbar 24 supported thereby, denoted by arrow W, will apply a torque, denoted by arrow T, against first element 48, and through keys 64 and resilient biasing element 54, to second element 52, in a counterclockwise direction about pivotal axis 42. Because one end of second element 52 is connected by torque arm 80 to adjusting link 86, and thus to bolt 96, threaded fastener 102, bracket 100 and rib 46, at least that end of second element 52 is not able to pivot or rotate in the counterclockwise direction. As a result, torque T will create a torsional loading condition τ on that assembly, particularly on biasing element 54 and second element 52. Increasing weight W, and/or applying a force for pivoting support arm 32 downwardly (counterclockwise) relative to biasing element 54 and second element 52 will increase torque T and thus the amount or level of torsional loading condition τ. Conversely, reducing weight W and/or applying a force for pivoting arm 32 clockwise relative to second element 52 will decrease torque T and thus the level of torsional loading condition τ.

Resilient biasing element 54 is designed to have sufficient elasticity or resiliency properties such that anticipated loads exerted against it, e.g., torque T, will be sufficient to elastically deform it to a known limited extent, such that first element 48 and arm 32 will be capable of pivoting or rotating counterclockwise about axis 42 relative to second element 52, by a limited amount. As this occurs, biasing element 54 will store energy, so as to exert an upwardly (clockwise) directed preload force, denoted by arrow PF (FIG. 8) against first element 48, and thus, arm 32. This preload force PF is advantageous, as it will urge first element 48 and arm 32 to pivot in the opposite or clockwise direction, to thereby reduce the amount of force at least initially required to pivot arm 32 in that direction.

Additionally, by tightening or loosening fastener 102, an adjusting force, denoted by arrow FA, can be exerted against adjusting bolt 96 in varying amounts, to draw or pull adjusting link 86 and torque arm 80 toward bracket 100. Force FA will apply a second torque TA against second element 52, but in a direction opposite the direction of torque T. This will act to increase the magnitude of torsional loading condition τ and consequently the preload force PF resulting from the stored energy in biasing element 54. In this manner, it can be seen that preload force PF can be desirably increased or decreased by an amount corresponding to the applied adjusting force FA. When a desired preload force PF, and position of support arm 32 and cutterbar 24, has been achieved, fasteners 74 and bolts 78 through adjusting flange bushing 68 can be tightened to fix bushing 68 to rib 46 at the selected position, to hold the preload force PF at the selected value, and support arm 32 in its selected position.

As an additional feature, because only one end of second element 52 is fixed to frame 40, torsional loading condition τ will act to urge that member to twist, and it can be configured, e.g., have selected torsional elasticity, so as to resiliently yield to torsional conditions that exceed the elasticity of resilient biasing element 54 to a desired extent. Thus, second element 52 and biasing element 54 can be selected such that torsional loading conditions τ greater than a certain level can effect resilient deformation of element 54 to a larger extent, and element 52 to a lesser extent, to avoid damage to biasing element 54 when near its elastic limit.

To illustrate the capabilities of the invention, in FIG. 7, support arm 32 is illustrated being generally horizontal supporting cutterbar 24. If the first end of support arm 32 and/or cutterbar 24 is supported in this position, e.g., on blocks or the like, and adjusting flange bushing 68 is free, torque T will have a very low value, or even be zero, and if adjusting force FA is set to a low value or zero, the resulting torsion load condition τ and preload force PF will be low or zero. If adjusting flange bushing 68 is fixed in this position, the preload force at this position will be set at this value.

Referring to FIG. 8, if subsequently, if the support of support arm 32 is removed such that the support arm and first element 48 are pivoted downward (counterclockwise) about second element 52 from the position of FIG. 7 (dotted lines), to a representative normal operation position (solid lines), for instance, such that first end 34 of arm 32 is resting on a ground surface 104, as also generally represented in FIG. 1, weight W will apply torque T, and preload adjusting mechanism 66 will apply torque TA, both as a function of the degree of pivotal movement of support arm 32 relative to the position of FIG. 7, such that the resulting torsion loading condition τ and preload force PF will be correspondingly increased, urging support arm 32 (and the cutterbar) upwardly. When in this position, if arm 32 is lifted by an externally applied force, e.g., during operation as a result of contact with a raised feature of the ground, firmer ground, a rock, or the like, the preload force PF will be exerted to reduce the externally applied force or effort required to at least initially raise arm 32. Conversely, if arm 32 encounters a depression, soft grounder surface, or the like, so as to pivot down even more, the amount of torsional loading and thus the preload force PF will be increased. As a result, subsequent upward pivoting of arm 32, and related structure, e.g., cutterbar, header frame, etc., will be assisted by force PF, which will gradually reduce with the release of the stored energy, such that support arm 32 and the cutterbar will more smoothly pass over changing ground characteristics, and impact forces, drag, and the like, will be reduced, with correspondingly less vibration transfer to the operator cab and the like. And, because biasing element 54 is preferably selected to be of an elastomeric material, the stored energy will exert preload force PF in a predictable damped or controlled manner as arm 32 is raised, thereby reducing any tendency to cause bouncing or chattering.

Additionally, in reference to FIG. 8, it should be noted that as an alternative, adjusting flange bushing 68 could be fixed to the frame with support arm 32 in this position, or a similar position, such that no, or a lesser, preload force PF will be exerted when arm 32 is supported, e.g., on ground surface 104 in this position. In this instance, or that described above, it should be noted that across the width of the header, the respective adjusting mechanisms 66 of support arms 32 can be set individually, e.g., fixed position of adjusting flange bushing 68 and tightness of adjusting fastener 102, as required or desired for achieving a desired positioning of the support arm and cutterbar, and preload force condition at that location. Here, it should be noted that it is anticipated that the support apparatus 26 at different locations along the width of a header will often carry different loads, e.g. resulting from the presence of drive apparatus, and thus, the presence of adjusting mechanism 66 allows compensating for this, to achieve desired evenness of the position of cutterbar 24 along the width of the header, and also evenness in the preload forces created.

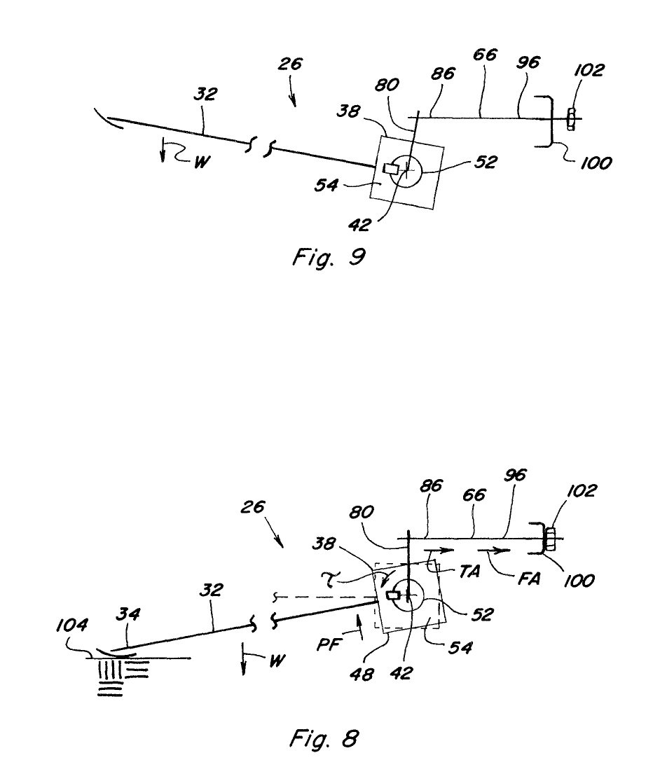

In FIG. 9, support arm 32 is shown in a significantly raised position, which can be representative of, for instance, the locked up position of FIG. 2. To place support arm 32 and thus the cutterbar in this position, the header can be lowered while those elements are held up, e.g., by support on blocks or the like, to preload biasing element 54 in the opposite direction to that discussed above, that is, downwardly (not shown). Alternatively, and as shown, adjusting flange bushing 68 can be released from the frame such that adjusting mechanism 66 will move with second element 52 and torque arm 80, e.g., such that adjusting bolt 96 will move through bracket 100 to space fastener 102 therefrom. In this way, advantageously, no torsional loading condition is exerted against biasing element 54 by weight W or the adjusting mechanism when the support arm is locked up. Then, to reconfigure in the float mode, with the desired preload, arm 32 is unlocked and lowered to the position of FIG. 7 (or other desired set position), and adjusting flange bushing 68 fixed to the frame in the above described manner. Appropriate markings can be provided on mechanism 66 and frame 40, e.g., hash marks or the like, to provide reference for achieving repeatability of the applied forces. If threaded fastener 102 has be previously set to a desired adjusting force, that setting will be present, or fastener 102 can be adjusted as desired or required for making another setting.

Referring also to FIG. 10, which is a simplified schematic top view of support apparatus 26, as noted above, in operation, cutterbar 24 will be reciprocatingly moved, as denoted by arrow R, which will translate into side-to-side vibrations, denoted by arrows V, exerted by arm 32 against first element 48. In turn, element 48 will transfer vibrations V to resilient biasing element 54. The resilient property of biasing element 54 is preferably selected to absorb and dissipate at least a substantial portion of vibrations V, such that second element 52, adjusting mechanism 66, and frame 40 are largely isolated therefrom. Thus, resilient biasing element 54 is configured and operable for reducing transmission to second element 52, of both shock loads from moving contact and impacts with features and characteristics of ground surface 104 (FIG. 8) and also vibrations V emanating from the reciprocating operation of cutterbar 23, which is another advantage of the invention.

As best shown in FIG. 2, as another feature of support apparatus 26 of the invention, a damping mechanism 106 can be provided, connected between second end 36 of support arm 32, and frame 40. Damping mechanism 106 includes a pair of arms 108 mounted about first element 48 in connection with second end 36, and extending rearwardly in cantilever relation thereto. One end of a fluid cylinder 110 is disposed between and pivotally connects to arms 108 at a pivot joint 112, and an opposite end connects to frame 40 at a second pivot joint 114. Fluid cylinder 110 is configured for damping upward and downwardly movements of support arm 32, and shock loads and vibrations generated by contact with ground features, e.g., rocks, and characteristics such as firm and/or raised regions, in cooperation with adjustable preload mechanism 38. Mechanism 106 can also act to damp vibrations emanating from cutterbar 24 and apparatus 26 when in the locked up position.

Referring also to FIGS. 11, 12 and 13, support apparatus 26 is shown including the second embodiment of an adjustable torsional preload mechanism 116 connecting second end 36 of support arm 32 to a frame 40 of header 22 for upward and downward pivotal movement relative to the frame about a pivotal axis 42, as denoted by arrow A in FIG. 2, like parts of mechanism 116 and mechanism 38 being identified by like numerals. Adjustable torsional preload mechanism 116 is preferably mounted or connected to a suitable portion of frame 40, which can be, but is not limited to, ribs 44 and 46. Here, mechanism 116 includes a first element 48 which is preferably a tubular member also having a rectangular sectional shape and constructed of a suitable material, such as a metal, and extending transverse to support arm 32. First element 48 is fixedly connected to second end 36 of arm 32, in a suitable manner, here using a bracket 118, which can be welded, fastened or otherwise connected to second end 36, and which has an upwardly open C-shape and includes opposing holes 120 configured for matingly receiving and holding first element 48. First element 48 defines and encloses a cavity 50 at least generally centered about and containing pivotal axis 42. A second element 52 which preferably comprises a solid shaft, also preferably of a suitable metal material, extends through cavity 50 centered about pivotal axis 42, such that first element 48 extends about and contains second element 52. Second element 52 also preferably has a rectangular sectional shape, and is of a sufficiently small sectional extent, so as to be receivable in cavity 50 oriented at about a 90 degree offset angle to element 48 about axis 42. It can be seen that, as a result of this offset relationship, cavity 50 is divided by second element 52 into four smaller triangular sections. Second element 52 additionally includes opposite axially outwardly extending ends 122 which are of sufficient length so as to be matingly received in bushings 124 mounted on ribs 44 and 46 of frame 40, respectively, for holding second element 52 in axially aligned relation to axis 42. Bushings 124 are preferably isolation type bushings, each having an elastomeric ring or other suitable element extending about the end 122 supported by the bushing, for absorbing and damping transmission of vibrations, including vibrations V resulting from reciprocating movements R of the cutterbar to frame 40, and can be fixedly mounted to ribs 44 and 46 in the manner of the attachment of adjusting bushings 68 thereto, or any other suitable manner.

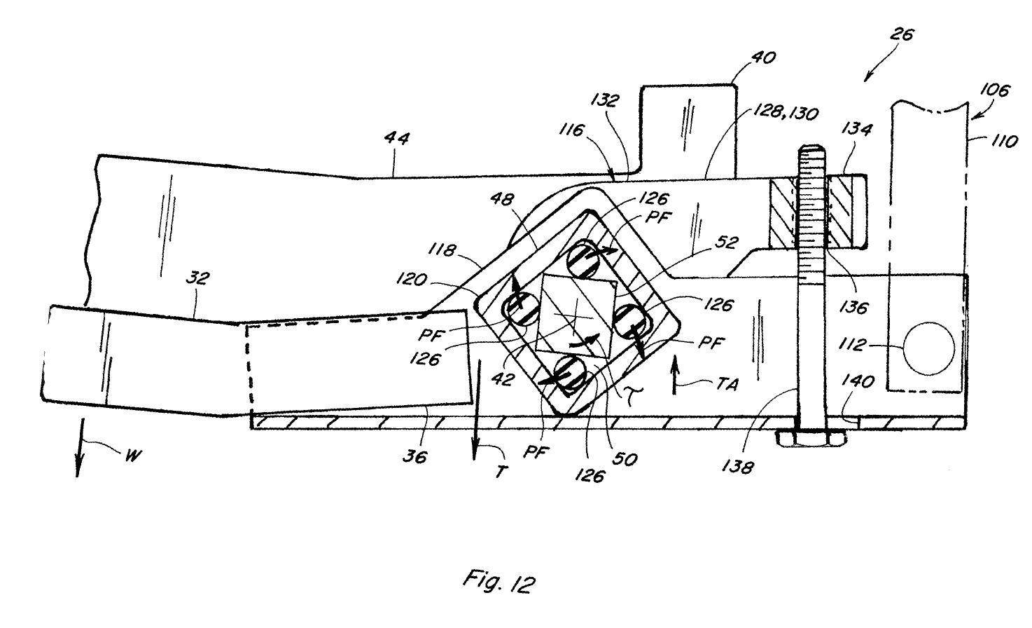

Mechanism 116 additionally includes a plurality of resilient biasing elements 126, of a suitable material, such as, but not limited to, a resiliently compressible elastomeric material, such as a natural and/or synthetic rubber, disposed respectively, in the four sections of cavity 50 between first element 48 and second element 52. Biasing elements 126 are simultaneously compressible between the inner surface of element 48 and the outer surface of element 52, by relative pivoting or rotation of those elements about axis 42. Here, referring more particularly to FIG. 12, weight W of support arm 32 and components supported thereby, e.g., the segment of the cutterbar supported thereby, will exert torque T in the counterclockwise direction, against first element 48. Since ends 122 of second element 52 are restrained from pivoting, torque T will urge element 48 to rotate or pivot in the counterclockwise direction relative to element 52 about axis 42. This will create a torsional loading condition τ, between elements 48 and 52, which will exert a compression force on biasing elements 126, and act to twist the center portion of element 52 relative to opposite ends 122 thereof. As a result of the compression force and elasticity of biasing elements 54, they will store energy, which will be exerted as preload forces in clockwise direction, denoted by arrows PF, against the inner surface of first element 48, and in opposition to torque T. Additionally, if torque T is sufficient to cause elastic torsional deformation of second element 52, this will increase preload forces PF. The resilient nature of elements 126 will also aid in damping vibrations V.

To allow adjustment of preload forces PF, mechanism 116 additionally includes a preload adjusting mechanism 128, including a torque arm 130 having a split yoke 132 fixedly mounted to ends 122, respectively, of second element 52. Torque arm 130 has an opposite end including a threaded block 134 supported in cantilever relation, including a threaded hole 136, which receives a threaded end of an adjusting bolt 138. The opposite end of adjusting bolt 138 passes through a hole 140 in a center region of bracket 118. Hole 140 can be elongate, to accommodate movement of bolt 138 therein perpendicular to axis 42. As a result, when adjusting bolt 138 is tightened, bracket 118 is urged upwardly toward block 134 and torque arm 130, which operates to urge first element 48 and support arm 32 to pivot in the counterclockwise direction about axis 42. This creates a torque TA, directed in the same direction as torque T, which will increase torsional loading condition τ, and thus the compression loading of biasing elements 126, and correspondingly increase preload forces PF exerted against first element 48, urging it to pivot in a clockwise direction about axis 42, as shown in FIG. 12. This is desirable, as this is the direction for raising support arm 32, which provides the advantages discussed above in reference to mechanism 38. Conversely, loosening adjusting bolt 138 will reduce torque TA, to thereby reduce the preload force PF.

As a result, in operation, if arm 32 is lifted, e.g., external force is applied in an upward direction during operation as a result of contact with a raised feature of the ground, firmer ground, a rock, or the like, the preload forces PF will be exerted to reduce the amount of the externally applied force or effort required to at least initially raise arm 32. Conversely, if arm 32 encounters a depression, soft ground surface, or the like, so as to pivot down even more, the amount of torsional loading and thus the preload force PF will be increased. As a result, subsequent upward pivoting of arm 32, and related structure, e.g., cutterbar, header frame, etc., will be assisted by force PF, which will gradually reduce with the release of the stored energy, such that support arm 32 and the cutterbar will more smoothly pass over changing ground characteristics, and impact forces, drag, and the like, will be reduced, with correspondingly less vibration transfer to the operator cab and the like. And, because biasing elements 126 are preferably selected to be of an elastomeric material, the stored energy will exert preload forces PF in a predictable damped or controlled manner as arm 32 is raised, thereby reducing any bouncing or chattering.

Again, support apparatus 26 is shown including a damping mechanism 106 connected between second end 36 of support arm 32, and frame 40. More particularly, one end of a fluid cylinder 110 of damping mechanism 106 pivotally connects to bracket 118 at a pivot joint 112, and an opposite end connects to frame 40 at a second pivot joint 114. Fluid cylinder 110 again is configured for damping upward and downwardly movements of support arm 32, and shock loads and vibrations generated by contact with ground features, e.g., rocks, and characteristics such as firm and/or raised regions, in cooperation with adjustable preload mechanism 116.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. Support apparatus for a flexible cutterbar of a header for an agricultural plant cutting machine, comprising:
an elongate support arm having a first end configured for attachment in supportive relation to a flexible cutterbar, and a second end opposite the first end; and
an adjustable torsional preload mechanism configured for connecting the second end of the support arm to the header frame for upward and downward pivotal movement relative to the frame about a pivotal axis, the mechanism including a first element connected to the support arm and disposed about a second element configured for connection to the frame, at least one resilient biasing element disposed between the first element and the second element, the support arm and the first element being configured for creating a torsional loading condition on the second element and the biasing element operable for resiliently biasing the biasing element so as to exert a preload force in opposition to the torsional loading condition, and a preload adjusting mechanism in connection with at least one of the first element and the second element and operable for selectably increasing or decreasing the biasing of the at least one resilient biasing element in a manner for adjusting the preload force.

2. Support apparatus of claim 1, wherein the first element comprises an inner surface bounding an interior cavity containing the second element, the second element comprises a shaft, and wherein the at least one resilient biasing element comprises at least one elastomeric element disposed in the interior cavity and bearing against the inner surface for exerting the preload force against the first element, and wherein the at least one elastomeric element is configured and disposed for damping vibrations emanating from side-to-side reciprocating movements of the cutterbar and limiting transmission of the vibrations to the frame.

3. Support apparatus of claim 2, comprising a plurality of the elastomeric elements disposed at spaced locations about the shaft.

4. Support apparatus of claim 2, wherein the first element has a multiple sided shape and the shaft has a multiple sided shape smaller than the first element.

5. Support apparatus of claim 2, wherein the at least one elastomeric element is bonded to at least one sleeve mounted about the shaft for rotation therewith about the pivotal axis.

6. Support apparatus of claim 5, wherein the sleeve is mounted to the shaft by at least one key.

7. Support apparatus of claim 1, wherein the preload adjusting mechanism is connected between the frame and the second element so as to be movable relative to the frame for selectably adjusting the preload force, and wherein the adjusting mechanism is fixable to the frame for setting the selected preload force.

8. Support apparatus of claim 7, wherein the preload adjusting mechanism comprises a torque arm connected to the first element or the second element and movable through a range of positions for adjusting the preload force.

9. Support apparatus of claim 8, further comprising a threaded assembly connected between the torque arm and the frame and threadedly engageable for selecting the preload force, and wherein the element to which the torque arm is connected is fixable to the frame for setting the selected preload force.

10. Support apparatus of claim 1, wherein the preload adjusting mechanism is connected between the first element and the second element.

11. Support apparatus of claim 1, further comprising a damping element connected between the support arm and the frame and operable for damping relative vertical movements therebetween.

12. Apparatus for applying a preload force against a flexible cutterbar of a header for an agricultural plant cutting machine, comprising:
an assembly including a first element configured for supporting an end of an elongate support arm having an opposite end configured for attachment in supportive relation to a flexible cutterbar, a second element configured for attachment to a frame of the header, the first element being disposed about the second element, and at least one resilient biasing element disposed between the first element and the second element and configured for allowing relative pivotal movement therebetween, the biasing element being adjustably biasable by a torsional condition created between the first element and the second element, so as to apply a preload force against the first element in a direction for biasing the support arm upwardly; and
a preload adjusting mechanism in connection with at least one of the first element and the second element and operable for selectably biasing the at least one resilient biasing element in a manner for adjusting the preload force.

13. Apparatus of claim 12, wherein the second element comprises a shaft and the first element comprises an inner surface bounding an interior cavity containing the shaft, and wherein the at least one resilient biasing element comprises at least one elastomeric element disposed in the interior cavity and bearing against the inner surface and the shaft for exerting the preload force against the first element, and wherein the elastomeric element is disposed and configured for damping at least a portion any side-to-side vibrations emanating from the cutterbar and limiting transmission of the vibrations to the frame.

14. Apparatus of claim 13, comprising a plurality of the elastomeric elements disposed at spaced locations about the shaft.

15. Apparatus of claim 13, wherein the first element has a multiple sided shape and the shaft has a multiple sided shape smaller than the first element.

16. Apparatus of claim 13, wherein the at least one elastomeric element is bonded to at least one sleeve mounted about the shaft for rotation therewith about the pivotal axis.

17. Apparatus of claim 16, wherein the sleeve is mounted to the shaft by at least one key.

18. Apparatus of claim 12, wherein the preload adjusting mechanism is configured to be connectable between the frame and the second element so as to be movable relative to the frame for selecting the preload force, and wherein the adjusting mechanism is fixable to the frame for setting the selected preload force.

19. Apparatus of claim 18, wherein the preload adjusting mechanism comprises a torque arm connected to the second element and movable for pivoting the second element about the pivotal axis relative to the first element, through a range of positions for selecting the preload force.

20. Apparatus of claim 19, further comprising a threaded assembly connectable between the torque arm and the frame so as to be threadedly operable for selecting the preload force, and wherein the second element is configured to be fixable to the frame for setting the selected preload force.

21. Apparatus of claim 12, wherein the preload adjusting mechanism is connected between the first element and the second element.

22. Apparatus of claim 12, further comprising a damping element configured to be connected between the support arm and the frame so as to be operable for damping relative vertical movements therebetween.

23. Support apparatus for a flexible cutterbar of a header for an agricultural plant cutting machine, comprising:
an elongate support arm having a first end configured for attachment in supportive relation to a flexible cutterbar, and a second end opposite the first end; and
an adjustable preload mechanism configured for connecting the second end of the support arm to the header frame for upward and downward pivotal movement relative to the frame about a pivotal axis, the mechanism including a first element connected to the second end of the support arm and disposed about a second element configured for fixed connection to the frame, and a plurality of resilient biasing elements disposed between the first element and the second element, the biasing elements being biasable by a torsional loading condition generated between the first element and the second element for applying a preload force therebetween in a direction for urging the support arm upwardly about the pivotal axis, and a preload adjusting mechanism in connection with at least one of the first element and the second element and operable for selectably adjusting the biasing of the resilient biasing elements against the first element and the preload force.

24. Support apparatus of claim 23, wherein the preload adjusting mechanism comprises a torque arm connected to the second element and movable for pivoting the second element about the pivotal axis relative to the first element, through a range of positions for selectably adjusting the preload force.

25. Support apparatus of claim 24, further comprising a threaded assembly connectable between the torque arm and the support arm so as to be threadedly operable for selectably adjusting the preload force.

26. Support apparatus of claim 23, further comprising a damping element configured to be connected between the support arm and the frame so as to be operable for damping relative vertical movements therebetween.

27. Support apparatus of claim 23, wherein the biasing elements are of a elastomeric material and are configured and positioned for damping side-to-side vibrations emanating from the cutterbar, and limiting transmission of the vibrations to the frame.

28. Support apparatus for a flexible cutterbar of a header for an agricultural plant cutting machine, comprising:
an elongate support arm having a first end configured for attachment in supportive relation to a flexible cutterbar, and a second end opposite the first end; and
an adjustable preload mechanism configured for connecting the second end of the support arm to the header frame for upward and downward pivotal movement relative to the frame about a pivotal axis, the mechanism including a shaft configured for fixed connection to the frame, a structural element disposed about the shaft and connected to the second end of the support arm, a resilient biasing element mounted on the shaft and cooperatively engaged with the structural element and biasable by a torsional loading condition between the structural element and the shaft for applying a preload force therebetween, and a preload adjusting mechanism in connection with at least one of the shaft and the structural element and operable for selectably adjusting the biasing of the resilient biasing element against the structural element for urging the support arm upwardly about the pivotal axis.

29. Support apparatus of claim 28, wherein the preload adjusting mechanism comprises a torque arm connected to the shaft and movable for pivoting the shaft about the pivotal axis relative to the second element, through a range of positions for selectably adjusting the preload force.

30. Support apparatus of claim 29, further comprising a threaded assembly connectable between the torque arm and the frame so as to be threadedly operable for selectably adjusting the preload force.

31. Support apparatus of claim 28, further comprising a damping element configured to be connected between the support arm and the frame so as to be operable for damping relative vertical movements therebetween.

32. Support apparatus of claim 28, wherein the biasing element comprises a resilient elastomeric material, and is configured and disposed for damping vibrations emanating from side-to-side reciprocating movements of the cutterbar, and limiting transmission of the vibrations to the frame.
